(19) United States
(12) Patent Application Publication
(10) Pub. No.: US 2022/0247488 A1
(43) Pub. Date: Aug. 4, 2022

(54) METHOD AND SYSTEM INSPECTING FIBERED OPTICAL COMMUNICATION PATHS

(71) Applicant: HUAWEI TECHNOLOGIES CO., LTD., Shenzhen (CN)

(72) Inventor: Zhiping JIANG, Kanata (CA)

(21) Appl. No.: 17/165,027

(22) Filed: Feb. 2, 2021

(51) Int. Cl. H04B 10/071; G01N 21/17; G01N 29/24

(52) U.S. Cl. CPC H04B 10/071; G01N 2021/1706; G01N 29/2418; G01N 21/1702

(57) ABSTRACT

A method for inspecting fibered optical communication paths. The method includes causing an acoustic signal generator near a fibered optical path to produce an acoustic signal; causing a laser to emit at least one optical pulse into the at least one fibered optical path at an emission time; detecting a plurality of reflected optical signals, each reflected optical signal having an arrival time; determining a distance traveled by each of the plurality of reflected optical signals, in which the distance traveled by a given reflected signal is determined at least in part on the arrival time of the given reflected signal and the emission time of the at least one optical pulse; and detecting for at least one distance traveled by the given reflected signal, a phase oscillation induced at least in part by the acoustic signal.

### CROSS-REFERENCE TO RELATED APPLICATIONS

This is the first application filed for the instantly disclosed technology.

### FIELD OF THE TECHNOLOGY

The present disclosure generally relates to the field of optical communication networks and, in particular, to methods and systems for inspecting communication paths in optical networks.

### BACKGROUND

Typical implementation of optical networks, such as, for example, dense wavelength division multiplex (DWDM) networks, involve providing a working path and a protection path in order to provide seamless communication. In the case of an optical fiber link failure in the working path, traffic can be routed through the protection path. Such path protection generally requires that the optical fiber links of the working path and the protection path are independent and physically separated to reduce the probability of the protection path and the working path being simultaneously interrupted due to a failure in a particular physical location.

However, the requirement of optical fiber links of the working path being independent and disjoint to the protection path is at times breached by the optical layer. Such breaches include at least a portion of working path and a portion of protection path sharing the same optical fiber, or different optical fibers within same optical cable, or different optical fiber cables that are spatially close to each other.

To this end, there remains an interest in being able to identify optical communication paths that have portions that are not sufficiently independent or separate.

### SUMMARY

By way of introduction, an object of the present disclosure (that is, one general purpose of this disclosure) is to provide a method and system for inspecting an optical communication system. Backscattered signals from one or more light pulses from fibered optical communication paths are inspected for the presence of a phase oscillation corresponding to a single tone or narrow-band acoustic signal emitted in the vicinity of one or more fibered optical communication path (for instance in the vicinity of a fiber cable). Based on presence (or absence) of the phase oscillation, it can be determined that the fibered optical communication paths are (or are not) in the vicinity of the acoustic signal source. Use of a narrow-band acoustic signal allows greater filtering and thus high signal-to-noise ratio and greater distance detection compared to similar methods relying on natural noise or broadband signals.

According to one aspect of the present technology, there is provided a method for inspecting at least one fibered optical communication path. Steps of the method include causing, by a controller, an acoustic signal generator to produce an acoustic signal, the acoustic signal generator being disposed near the at least one fibered optical path; causing, by the controller, a laser to emit at least one optical pulse into the at least one fibered optical path, the at least one optical pulse being emitted at an emission time; detecting, by at least one detector communicatively coupled to the controller and operatively connected to the at least one fibered optical path, a plurality of reflected optical signals, each reflected optical signal having an arrival time; determining, by the controller, a distance traveled by each of the plurality of reflected optical signals, in which the distance traveled by a given reflected signal is determined at least in part on the arrival time of the given reflected signal and the emission time of the at least one optical pulse; and detecting, by the controller, for at least one distance traveled by the given reflected signal, a phase oscillation induced at least in part by the acoustic signal.

In some implementations, the at least one detector is a first detector; the at least one fibered optical path is a first fibered optical path; the plurality of reflected optical signals is a first plurality of reflected optical signals. The method further includes detecting, by a second detector communicatively coupled to the controller and operatively connected to a second fibered optical path, a second plurality of reflected optical signals from the second fibered optical path; detecting, by the controller, the phase oscillation; and determining, by the controller, that at least a portion of the second fibered optical path is disposed in a same fiber cable as at least a portion of the first fibered optical path.

In some implementations, the method further includes determining a second distance traveled by a portion of the second plurality of reflected optical signals having the phase oscillation, wherein the second distance indicates a distance between the second detector and the acoustic signal generator.

In some implementations, the method further includes causing the acoustic signal generator to produce the acoustic signal at a second position, the second position being near a different portion of the at least one fibered optical path; detecting a second plurality of reflected optical signals, reflections in the fibered path from each one of the plurality of optical pulses creating some of the plurality of reflected optical signals, each one of the second plurality of reflected optical signals having a second arrival time; determining a second distance traveled by each of the second plurality of reflected optical signals; and detecting, for at least a portion of the second plurality of reflected optical signals, the phase oscillation introduced at least in part by the acoustic signal at the second position, the second distance traveled by the portion of the second plurality of reflected optical signals having the oscillation indicating a distance along the fibered path from the detector to the acoustic signal generator at the second position.

In some implementations, the method further includes receiving at least one indication of physical locations of the first position and the second position of the acoustic signal generator; mapping physical positioning the at least one fibered optical path based at least in part of the at least one indication of the physical locations of the first position and the second position.

In some implementations, causing the laser to emit the at least one optical pulse includes causing the laser to emit a plurality of pairs of two optical pulses separated by a pre-determined time delay; and determining the arrival time of each one of the plurality of reflected optical signals includes detecting an interference at the at least one detector of reflections of each pair of two optical pulses.

In some implementations, causing the acoustic signal generator to produce the acoustic signal comprises causing the acoustic signal generator to produce a narrow-band acoustic signal.

In some implementations, detecting the phase oscillation includes suppressing signals with phase oscillations not corresponding to the narrow-band acoustic signal.

In some implementations, detecting the phase oscillation comprises performing a fast Fourier transform (FFT) of an irradiance of the plurality of reflected optical signals, the irradiance being a function of the arrival time of portion of the second plurality of reflected optical signals.

In some implementations, the plurality of reflected optical signals are produced by Rayleigh backscattering at a plurality of distances along the at least one fibered optical path.

In some implementations, determining the distance traveled by a given reflected signal of the plurality of reflected optical signals through the at least one fibered optical path includes determining a time difference between the arrival time of the given reflected signal and the emission time of a given source pulse; and calculating the distance based on the time difference and the speed of light in the at least one optical communication path.

In some implementations, the at least one optical pulse includes at least a first optical pulse and a second optical; and the plurality of reflected optical signals includes at least a first plurality of reflected optical signals originating from the first optical pulse and a second plurality of reflected optical signals originating from the second optical pulse.

According to yet another aspect of the present technology, there is provided a system for determining a fibered communication path. The system includes a controller; a laser source communicatively coupled to the controller, the laser source being configured for operatively coupling to an optical communication path; at least one detector communicatively coupled to the controller, the at least one detector being configured to receive signals from the optical communication path; and an acoustic signal generator communicatively coupled to the controller. The controller is configured to: cause, by the controller, the acoustic signal generator to produce an acoustic signal near at least one fibered optical path; cause, by the controller, the laser source to emit at least one optical pulse into the at least one fibered optical path, the at least one optical pulse being emitted at an emission time; detect, by the at least one detector, a plurality of reflected optical signals, each one of the plurality of reflected optical signals having an arrival time; determine, by the controller, a distance traveled by each of the plurality of reflected optical signals, in which the distance traveled by a given reflected signal is determined at least in part on the arrival time of the given reflected signal and the emission time of the at least one optical pulse; and detect, by the controller, for at least one distance traveled by the given reflected signal, a phase oscillation produced at least in part by the acoustic signal.

In some implementations, causing the laser to emit the at least one optical pulse includes causing the laser to emit a plurality of pairs of two optical pulses separated by a pre-determined time delay; and the controller is further configured to determine the arrival time of each one of the plurality of reflected optical signals by detecting an interference at the at least one detector of reflections of each pair of two optical pulses.

In some implementations, the controller is configured to cause the acoustic signal generator to produce the acoustic signal by causing the acoustic signal generator to produce a narrow-band acoustic signal.

In some implementations, the controller is configured to detect the phase oscillation by suppressing signals with phase oscillations not corresponding to the narrow-band acoustic signal.

In some implementations, the controller is configured to detect the phase oscillation by performing a fast Fourier transform (FFT) of an irradiance of the plurality of reflected signals, the irradiance being a function of the arrival time of the plurality of reflected signals.

In some implementations, the plurality of reflected optical signals are produced by Rayleigh backscattering at a plurality of distances along the at least one fibered optical path.

According to yet another aspect of the present technology, there is provided a method for inspecting a fibered optical communication path. The method includes launching a single tone acoustic signal near the fibered optical communication path; sending, into the fibered optical communication path, a first two optical pulses separated by a pre-determined time separation; receiving reflected optical power over an elapsed time; repeating, for a pre-determined number of total pulses, sending additional two optical pulses separated by the pre-determined time separation and receiving the optical power over the elapsed time; and performing tone detection, based at least in part on the single tone acoustic signal, on the optical power received.

In some implementations, performing tone detection comprises detecting phase oscillation corresponding to the single tone acoustic signal in the reflected optical power received over the elapsed time.

### BRIEF DESCRIPTION OF THE FIGURES

The features and advantages of the present disclosure will become apparent from the following detailed description, taken in combination with the appended drawings, in which:

FIG. 1 depicts a conceptual diagram of an optical network;

FIG. 2 depicts a high-level schematic diagram of an optical network including a system for inspecting fibered optical communication paths, in accordance with various embodiments of the present disclosure;

FIG. 3 depicts a high-level block diagram of representative components for a processing unit of the system of FIG. 2, in accordance with various embodiments of the present disclosure;

FIG. 4 illustrates a non-limiting example of an acoustic signal generator of the system of FIG. 2, in accordance with various embodiments of present disclosure;

FIG. 5 depicts a flowchart of one method of inspecting an optical communication path according to various embodiments of present technology;

FIG. 6 depicts a series of example measurements according to various embodiments of present technology;

FIG. 7 depicts a flowchart of another method of inspecting an optical communication path according to various embodiments of present technology;

FIG. 8 schematically depicts two-pulse propagation used in the method of FIG. 7; and

FIG. 9 illustrates an experimental outcome of a frequency spectrum extracted by a detector, in accordance with various embodiments of present disclosure.

It is to be understood that throughout the appended drawings and corresponding descriptions, like features are identified by like reference characters. Furthermore, it is also to be understood that the drawings and ensuing descriptions are intended for illustrative purposes only and that such disclosures are not intended to limit the scope of the claims.

### DETAILED DESCRIPTION

Various representative embodiments of the described technology will be described more fully hereinafter with reference to the accompanying drawings, in which representative embodiments are shown. The present technology concept may, however, be embodied in many different forms and should not be construed as limited to the representative embodiments set forth herein. Rather, these representative embodiments are provided so that the disclosure will be thorough and complete, and will fully convey the scope of the present technology to those skilled in the art. In the drawings, the sizes and relative sizes of layers and regions may be exaggerated for clarity. Like numerals refer to like elements throughout.

It will be understood that, although the terms first, second, third, etc. may be used herein to describe various elements, these elements should not be limited by these terms. These terms are used to distinguish one element from another. Thus, a first element discussed below could be termed a second element without departing from the teachings of the present technology. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is only intended to describe particular representative embodiments and is not intended to be limiting of the present technology. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “controller”, “processor” or “processing unit”, may be provided through the use of dedicated hardware as well as hardware capable of executing software in association with appropriate software and according to the methods described herein. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules or units which are implied to be software, may be represented herein as any combination of flowchart elements or other elements indicating performance of process steps and/or textual description. Such modules may be executed by hardware that is expressly or implicitly shown, the hardware being adapted to (made to, designed to, or configured to) execute the modules. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present disclosure.

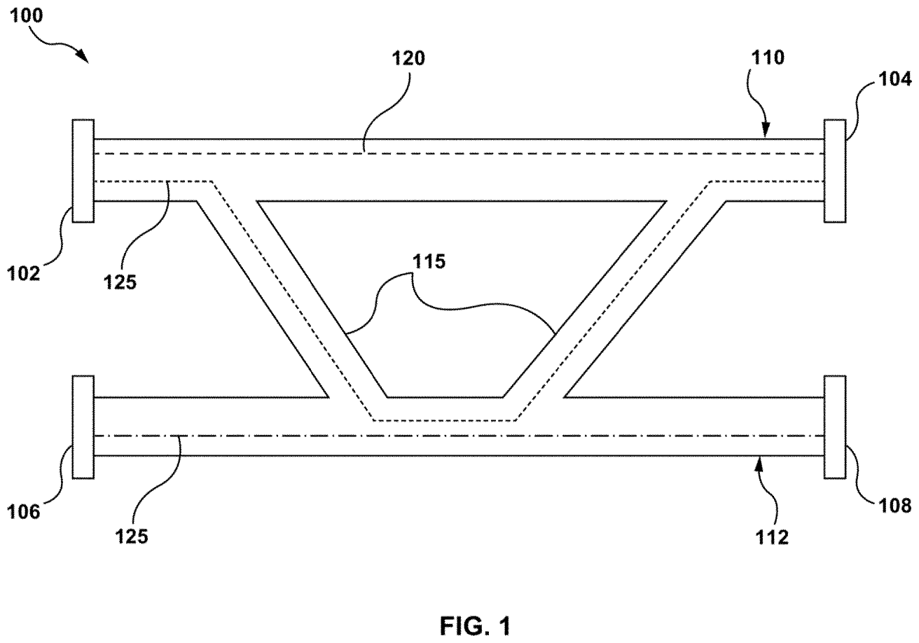

Referring now to the drawings, FIG. 1 depicts a conceptual diagram of an optical network 100 that may be addressed by the systems and methods presented herein. As shown, the optical network 100 typically includes a plurality of optical nodes 102, 104, 106, 108 that may include optical multiplexing sections (OMSs) comprising optical add-drop multiplexers, such as, for example, a reconfigurable optical add-drop multiplexers (ROADMs) each containing at least one wavelength selective switch (WSS). Each node may be configured to add, remove, and/or reroute a wavelength. Each OMS based node may further comprise multiple optical transport sections (OTSs), where at each OTS the wavelength remains same.

It is to be contemplated that nodes in the optical network may be communicatively connected by virtue of links including optical cables, where each optical cable may include a plurality of optical fibers. The optical fiber may be of any suitable type such as, for example, single mode optical fiber, multi-mode optical fiber, standard single mode fibers (SSMFs), large effective area fibers (LEAFs) or the like. The links also include a plurality of optical amplifiers, such as, for example, EDFAs. The link between two nodes further includes optical amplifiers.

By way of example, an implementation of the optical network 100 generally includes a plurality of fibers, embodying for instance working paths and protection paths, extending from node to node or location to location. While only four nodes and three fibers are illustrated, it should be understood that the optical network 100 generally includes many more nodes and fibers (in various more or less complex configurations) which form the network 100.

Any given working path and protection path pair may be disjoint in terms of optical fibers or optical cables. For instance, in the illustrated example, the fiber 120 extends through the fiber cable 110 from the node 102 to the node 104 and the fiber 122 extends through the fiber cable 112 from the node 106 to the node 108. These two fibers 120, 122, at least for the extent illustrated, are disjoint and geographically separated; colloquially, the fiber 120 and the fiber 122 do not share space, such that what happens with one fiber does not ordinarily affect the other. To this end, if the optical cable 110 or an optical fiber in the optical cable malfunctions due to any reason, traffic between node 102 and 104 may be redirected to the path between node 106 and 108. It should be noted that for actual working/protection pairs, the nodes 102/106 and 104/108 will generally be disposed close to one another (the Figures not being drawn to scale). In some non-limiting implementations, the fibers 120, 122, 125 could be connected between the same nodes (e.g. the nodes 102 and 104), including while arranged in a working/protection pair configuration.

Between any given pair of nodes, however, it is possible that optical fibers for different paths (e.g. the working and protection paths) become grouped in a same fiber cable or bundle of fibers. For practical considerations, for instance, it could be desirable or necessary to split larger fiber bundles (i.e. many fibers in one physical grouping) into smaller bundles (i.e. fewer fibers in more than one physical grouping) or re-group smaller fiber bundles into a relatively larger bundle. Over long distances, any given fiber could be separated from or regrouped with a neighboring fiber one or more times.

In the illustrated example, while the fiber 125 extends between the nodes 102 and 104 and would be assumed to belong to the fiber cable 110, a portion of the fiber 125 actually extends through a portion of the fiber cable 112 via two connecting passages 115 (shunts between the cables 110, 112 for example). As one non-limiting example, for practical considerations in the layout of the fiber cable 110 it could have been necessary to split a large fiber bundle extending from the node 102 into smaller groupings (including the portion 115) which then was regrouped with the bundle represented by the cable 112. A grouping of fibers, including the fiber 125, was then subsequently regrouped with the cable 110. It should be noted that while the fiber 125 is illustrated with sharp bends, this is simply for ease of illustration and such fibers passing from one grouping to another would curve slightly in order to limit risks such as breakage and signal leaking.

In such a case, damage to the fiber cable 112, especially between the nodes 106 and 108, could affect the fiber 125. The fiber 125 is thus not an adequate protection path for the fiber 122 in the illustrated example. Similarly, if the fiber 125 was arranged in a different fiber cable in the same duct, or in different ducts arranged in proximity, to the working path fiber 122, the fiber 125 may not be an adequate protection path.

Hence, a key point of interest while implementing working paths and protection paths on optical communication networks, such as the optical network 100, is to inspect different optical communication paths, to investigate physical proximity of the two paths and/or to map the actual physical positioning of one or more communication paths.

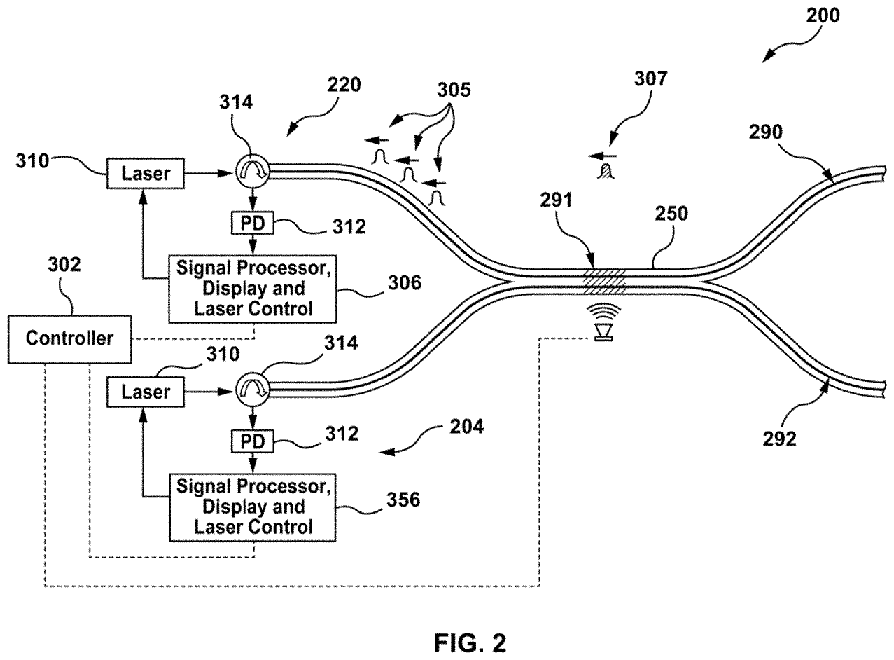

With reference to FIG. 2, a system 300 for inspecting optical communication systems to detect proximity of different optical communication paths will be described. The system 300, according to the disclosed embodiments, can be utilized to discover a defect of the working and protection paths sharing a fiber cable through the use of an acoustic signal generator 206, also referred to herein as a sound source 206.

Broadly, the system 300 functions as follows: to inspect the optical communication network 200, the acoustic signal generator 206 can be placed near an optical communication path, such as a fiber cable, in order to determine how many paths are directed between or near the path. As one non-limiting example and as is illustrated in FIG. 2, the acoustic signal generator 206 is placed near, e.g.,. alongside the fiber cable 250. Artisans of ordinary skill will readily understand that acoustic signal generator 206 and the fibered optical communication path, such as the fiber cable 250, are arranged with a distance between them such that the sound from the acoustic signal generator 206 is effectively able to induce a phase modulation within the fiber material of the fibered optical path. The exact distance between the two could vary depending on the embodiment; different factors will dictate how near the signal generator 206 needs to be to the fiber cable 250, including for example, sound signal strength and the medium surrounding the fiber cable 250.

As will be described in more detail below, the acoustic signal generator 206 is adapted and configured to generate a narrow frequency band acoustic signal, generally a single tone, in order to induce a localized disturbance in the optical fiber(s) of the fibered communication paths in the vicinity of the acoustic signal generator 206. The localized disturbance, generally speaking, is a modification of a portion of the fibered optical path induced by an opto-acoustic effect of the acoustic signal on the fiber materials. The effect is generally localized to a small area surrounding the acoustic signal generator 206, the opto-acoustic effect having a finite region of influence around the acoustic signal generator 206. Depending on the implementation, the acoustic signal could be produced in a frequency range of 0 to 1000 Hz, preferably below 100 Hz.

This localized disturbance induces an oscillating phase pattern over time, also referred to herein as an oscillating phase shift, in optical signals passing therethrough or reflecting therefrom. Optical pulses backscattering from portions of the optical paths with the localized disturbance can therefore be utilized to identify fibered communication paths in the vicinity of the acoustic signal generator 206 by detecting a phase oscillation frequency corresponding to the frequency of the acoustic signal. Any fibered optical communication path in which the phase pattern is detected can be determined to pass in the vicinity of the acoustic signal generator 206.

In the implementation illustrated in FIG. 2, for example, the detection of the phase pattern in both the fiber 290 and the fiber 292 thusly indicates that both the fibers 290, 292 pass through the fiber cable 250.

With the broad principles set out above, the system 300 will be described in more detail. The system 300 for inspecting optical communication paths according to the enclosed embodiments is illustrated, as one non-limiting example, as implemented inspecting a fibered optical communication path 290, specifically the fiber 290 as mentioned above. As will be described further below, portions of another fibered optical communication path 292 are in the vicinity of portions of the path 290.

The system 300 includes a controller 302 for performing methods of inspecting the fibered optical communication path 290, and for generally operating the components connected thereto. It is to be noted that the controller 302 may comprise one or more computing devices, represented as a single server 302, enabled to perform the tasks and methods described herein. Although represented as a single server, the controller 302 may be implemented as one or more real or virtual servers. Further, it will be appreciated that although the controller 302 has been shown external to optical network 200, in certain embodiments, the controller 302 may be incorporated with in a processing unit 306 each optical node of the system 200.

The fiber 290 is optically coupled to a node 202 for transmitting information therethrough according to methods generally known in the art. The node 202 includes a processing unit 306 for controlling light emitted into and detecting light received from the fibered optical communication path 290, and for generally operating the components connected thereto. It is to be noted that the processing unit 306 may comprise one or more computing devices, represented as a single server 306. Although represented as a single server, the processing unit 306 may be implemented as one or more real or virtual servers.

The fiber 292 is similarly optically coupled to a node 204 for transmitting information therethrough according to methods generally known in the art. The node 204 includes a processing unit 356 for controlling light emitted into and detecting light received from the fibered optical communication path 290, and for generally operating the components connected thereto. It is to be noted that the processing unit 356 may be differently configured in at least the way described above for the processing unit 306.

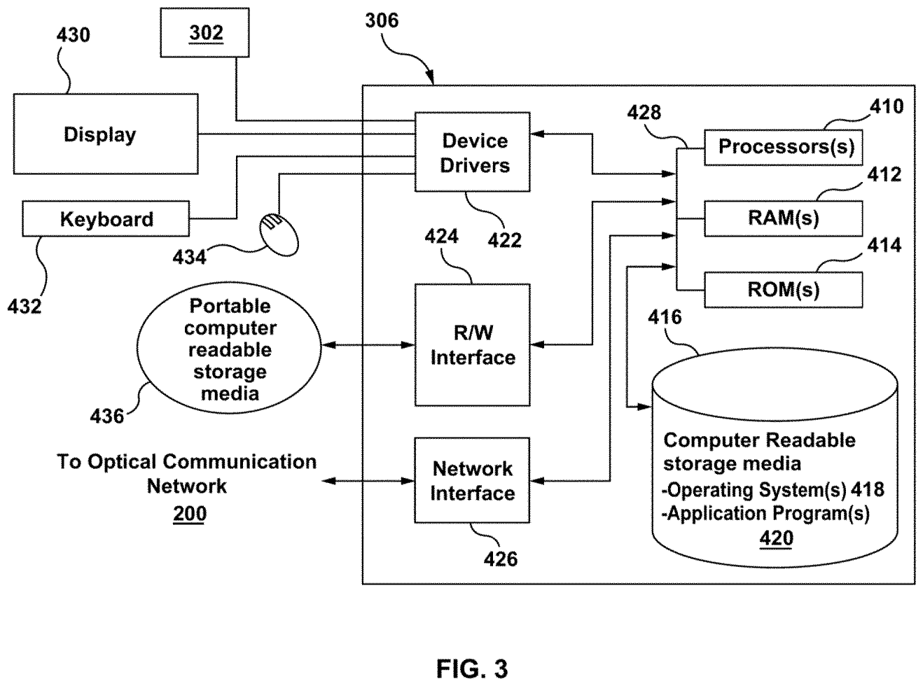

Additional implementational details of one non-limiting embodiment of the processing units 306, 356 will be described in more detail below with reference to FIG. 3, although it is contemplated that various implementations of processing units 306, 356 could be used.

Each node 202, 204 also includes a laser source 310 communicatively connected to the corresponding processing unit 306, 356. The laser source 310 is configured for operatively coupling to the corresponding fibered optical communication path 290, 292. Each node 202, 204 could incorporate one or more laser light sources configured to produce, emit, or radiate pulses of light with certain pulse duration. In certain embodiments, one or more pulsed laser light sources may comprise one or more laser diodes, such as but not limited to: Fabry-Perot laser diode, a quantum well laser, a distributed Bragg reflector (DBR) laser, a distributed feedback (DFB) laser, or a vertical-cavity surface-emitting laser (VCSEL). Just as examples, a given laser diode may be an aluminum-gallium-arsenide (AlGaAs) laser diode, an indium-gallium-arsenide (InGaAs) laser diode, or an indium-gallium-arsenide-phosphide (InGaAsP) laser diode, or any other suitable laser diode.

It is also contemplated that the emitted light may be single polarized, dual polarized, or randomly polarized, may have a particular polarization (e.g. linearly polarized, elliptically polarized, or circularly polarized).

Further, each node 202, 204 in the optical network 200 may incorporate multiple optical amplifiers, e.g., erbium-doped fiber amplifiers (EDFAs), for amplifying the optical signals. The optical network 200 may further employ one or more optical network elements and modules (which may include either or both of active and passive elements/modules), such as, for example, optical filters, WSSs, arrayed waveguide gratings, optical transmitters, optical receivers, processors and other suitable components. However, for purposes of simplicity and tractability, these elements have been omitted from FIG. 2.

Each node 202, 204 in further includes a detector 312 communicatively connected to the corresponding processing unit 306, 356. The detector 312 is arranged and configured to receive optical signals from the corresponding fibered optical communication path 290, 292. Each node 202, 204 also includes a circulator 314 operatively connecting the laser source 310 and the detector 312 to the corresponding fibered path 290, 292, such the light from the laser source 310 is directed into the fibered path 290, 292 and light signals reflected back from the fibered path 290, 292 are directed to the detector 312. In some implementations, the circulator 314 could be replaced with different optics, including a fiber coupler. The detector 312 is generally implemented as a photodetector 312 configured to convert the corresponding light intensity to an electrical signal and forward the electrical signal to processing unit 306, 356. It is also contemplated that the detector 312 could be differently implemented.

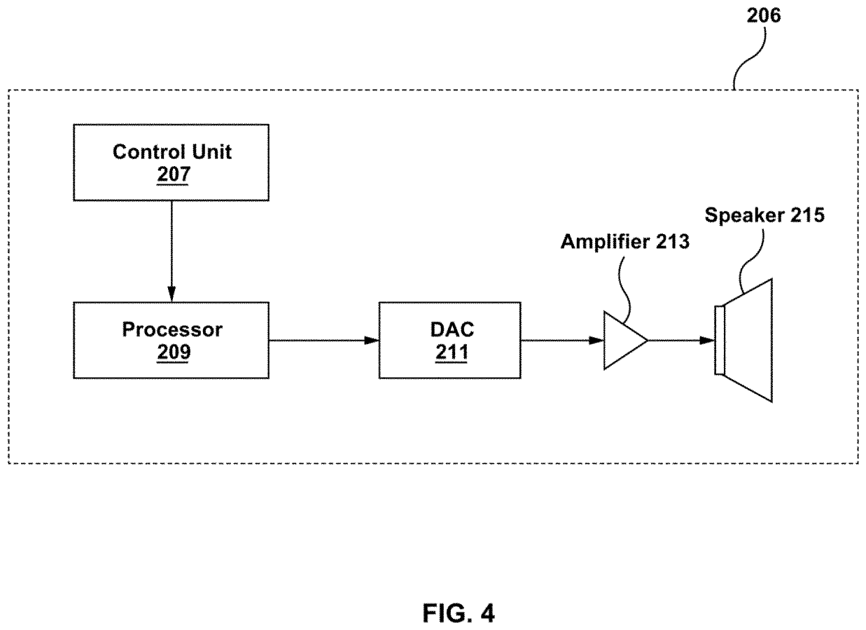

The system 300 further includes the acoustic signal generator 206 communicatively connected to the controller 302. Details of some implementations of the acoustic signal generator 206 are described below with reference to FIG. 4, but it is contemplated that various forms of acoustic signal generators, such as sound sources and generic speakers, could be used to implement the acoustic signal generator 206. According to the systems and methods provided by the embodiments described herein, the acoustic signal generator 206 is used to generate a narrow-band acoustic signal, also referred to herein as a signal tone acoustic signal. By using a single frequency (“tone”), or nearly single frequency depending on the capabilities of the specific acoustic signal generator, an oscillating phase effect, having a frequency corresponding to that of the acoustic signal, induced will be detectable and separable from random sources of noise which produce widely varying frequencies of phase modulation.

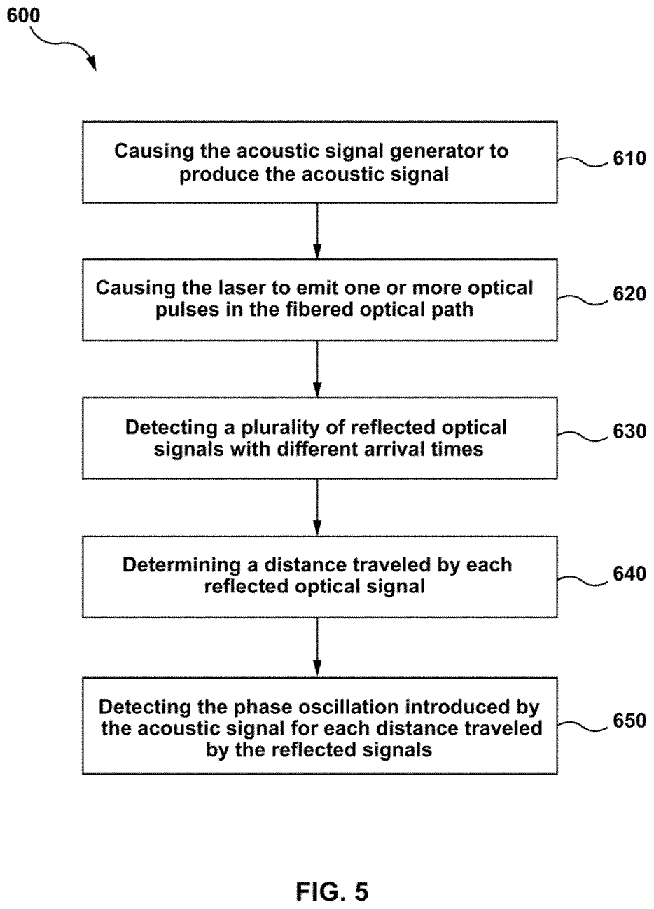

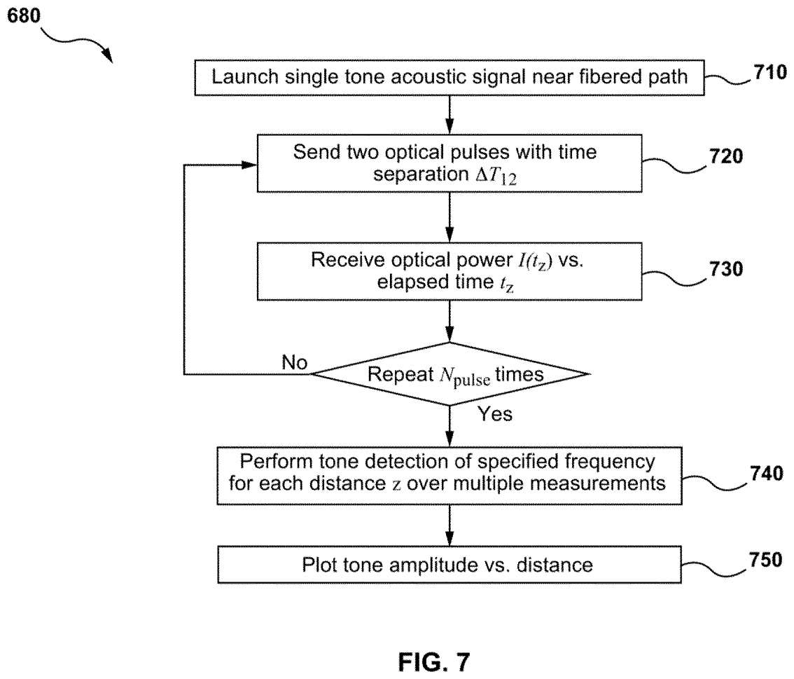

While the methods 600, 700 for utilizing the system 300 will be described in greater detail below with reference to FIGS. 5 and 7, the operation of the system 300 is generally performed as follows: to begin inspection of the fibered optical communication path 290, and the communication system 200 generally, the acoustic signal generator 206 creates a single tone acoustic signal in the vicinity of the fibered optical communication path 290. In the example illustrated, the acoustic signal generator 206 is specifically disposed next to the fiber cable 250. Due to opto-acoustic effects, the acoustic signal creates a localized disturbance 291 in the fibered optical communication path 290. The localized disturbance 291 creates a phase modulation that oscillates at the acoustic frequency in light pulses that encounter the localized disturbance 291, which aids in determining the distance along the fibered path 290 to the acoustic signal generator 206.

Specifically, to determine the distance from some pre-determined point (e.g., the laser source 310 or the detector 312) to the localized disturbance 291, one or more pulses of laser light are emitted and directed into the fibered path 290. Generally, the distance will be determined based on many pulses (e.g. 10,000 or 100,000), but it is contemplated that the system 300, and the methods described herein, could be run with fewer pulses. Due to Rayleigh backscattering, a small portion of each pulse is reflected back from a plurality of locations along the fibered path 290. A plurality of backscattered signals 305 are illustrated in FIG. 2. Backscattered signals from the portion of the fibered path 290 with localized disturbance 291, illustrated by backscattered pulse signal 307, have a phase modulation relative to backscattered signals 305 from undisturbed portions of the fibered path 290. By obtaining the time between pulse emission and reception of one or more phase modulated signals 307 at the detector 312 (T), the distance z along the fibered path 290 between the laser source 310 and the localized disturbance 291 can be determined by the Equation (1) below, where [symbol] is the speed of light in the fibered path 290.

$$z = \frac{v T}{2} \qquad ( 1 )$$

In some non-limiting example implementations, the system 300 can thus determine and/or map an unknown physical location of one or more portions of the fibered optical communication path 290, where the distance to the localized disturbance 291 can be compared to the physical location of the acoustic signal generator 206.

To map out multiple or different portions of the fibered optical communication path 290, the acoustic signal generator 206 could be mobile, such that it can be positioned at a number of different test points. In such an implementations, the acoustic signal generator 206 could include other components as well, such as, for example, a global positioning system (GPS), communication transmitter/receiver or the like. To this end, when the mobile acoustic signal generator 206 transmits the acoustic signal, as described above, the acoustic signal generator 206 also communicates with the controller 302 in order to provide timing information, GPS coordinates, exact acoustic signal frequency, etc. The controller 302 can then determine both distance along the fibered path 290, based on the acoustic signal detection as described above, as well as the physical positioning of the acoustic signal generator 206 relative to known portions of the communication system containing the unknown portions of the fibered path 290.

The physical distribution of the fibered optical communication path 290 can then be determined and mapped based on at least the distances determined between the laser 310 and/or the detector 312 and the acoustic signal generator 206, as well as the different test point GPS locations of the acoustic signal generator 206.

In some non-limiting example implementations, the controller 302 and/or the processing unit 306 could further be connected to additional detectors and/or different fibered optical communication paths for use in detecting paths that are not independent such as is described with respect to FIG. 2. In the non-limiting example of FIG. 2, the controller 302 is communicatively coupled to both nodes 202, 204 in order to have access to information regarding both fibered paths 290, 292. In some non-limiting implementations, it is contemplated that the processing units 306, 356 could be communicatively coupled together, without a separate controller, in order to perform the methods described herein.

In the illustrated example, the controller 302 receives information related to laser pulses emitted by the laser source 310 of the node 204 and backscattered signals received by the corresponding detector 312. The controller 302 can thus inspect backscattered signals for the presence of the phase modulation caused by the acoustic signal in the fibered path 292. In this way, possible independence of the paths 290, 292 could be verified, as appearance of the phase oscillation effect in the path 292 indicates that at least a portion of the path 292 comes into the vicinity of the acoustic signal generator 206, and thus into the vicinity of the path 290.

In cases where the acoustic signal generator 206 also communicates its physical location of the controller 302 and/or the processing unit 356, at least that portion of the fibered path 292 could also be mapped to an approximate location as described above in reference to the fibered path 290.

It will be appreciated that how the detectors 312, the controller 302, and/or the processing units 306, 356 identify the phase modulation in the light signal encountering the localized disturbance 291 should not limit the scope of present disclosure.

FIG. 3 depicts a high-level block diagram of representative components for the processing unit 306, in accordance with various embodiments of the present disclosure. It should be appreciated that FIG. 3 provides only an illustration of one implementation of the processing unit 306 and does not imply any limitations with regard to the environments in which different embodiments may be implemented. Many modifications to the depicted environment can be done to implement the processing unit 306 without departing from the principles of the embodiments presented herein.

As shown, the processing unit 306 employs one or more processors 410, one or more computer-readable random access memories (RAMs) 412, one or more computer-readable read only memories (ROMs) 414, one or more computer-readable storage media 416, device drivers 422, a read/write (R/W) interface 424, a network interface 426, all interconnected over a communications fabric 120. Communication fabric 428 may be implemented with any architecture designed for passing data and/or control information between processors (such as microprocessors, communications and network processors, etc.), memory, peripheral devices, and any other hardware components within a system.

One or more operating system(s) 418 and one or more application program(s) 420 are stored on one or more of computer-readable storage media 416 for execution by one or more of the processors 410 via one or more of the respective RAMs 412 (which typically include a cache memory). In the illustrated embodiment, each of computer-readable storage media 416 may be a magnetic disk storage device of an internal hard drive, CD-ROM, DVD, memory stick, magnetic tape, magnetic disk, optical disc, a semiconductor storage device such as RAM, ROM, EPROM, flash memory or any other computer-readable tangible storage device that can store a computer program and digital information.

The processing unit 306 may also include the R/W drive or interface 424 to read from and write to one or more portable computer readable storage media 436. Application programs 420 on said devices may be stored on one or more of the portable computer readable storage media 436, read via the respective R/W drive or interface 424 and loaded into the respective computer readable storage media 416.

It will be appreciated that in certain embodiments the application programs 420 stored on one or more of the portable computer readable storage media 436 may configure the processing unit 306 to provide various functionalities, in accordance with various embodiments of the present disclosure.

The application programs 420 on the processing unit 306 may be downloaded to the processing unit 306 from an external computer or external storage device via a communication network (for example, the Internet, a local area network or other wide area network or wireless network) and the network interface 426. From the network interface 426, the programs may be loaded onto the computer-readable storage media 416.

The processing unit 306 may also include a display screen 430, a keyboard or keypad 432, and a computer mouse or touchpad 434. The device drivers 422 may interface to display screen 430 for imaging, to a keyboard or keypad 432, to a computer mouse or touchpad 434, and/or to display the screen 430 (in case of touch-screen display) for pressure sensing of alphanumeric character entry and user selections. Device drivers 422, R/W interface 424 and network interface 426 may comprise hardware and software (stored on computer-readable storage media 416 and/or ROM 414). It is contemplated that in some non-limiting implementations, the display screen 430, the keyboard or keypad 432, and/or the computer mouse or touchpad 434 could implemented with the controller 302 alternatively or in addition to the processing unit 306.

The programs described herein are identified based upon the application for which they are implemented in a particular embodiment of the present disclosure. However, it should be appreciated that any particular program nomenclature herein is used merely for convenience, and thus the disclosure should not be limited to use solely in any specific application identified and/or implied by such nomenclature.

It will be appreciated that the processing unit 306 and/or the controller 302 could be a server, a desktop computer, a laptop computer, a tablet, a smartphone, a personal digital assistant or any device that may be configured to implement the present technology, as should be understood by a person skilled in the art.

FIG. 4 illustrates a non-limiting example of the acoustic signal generator 206 in accordance with various embodiments of present disclosure. It should be noted that the acoustic signal generator could be implemented in a variety of manners in different implementations of the present technology. It is contemplated that how the acoustic signals are generated and transmitted should not limit the scope of the present disclosure.

As shown, the acoustic signal generator 206 includes a control unit 207, a processor 209, a digital to analog convertor (DAC) 211, an amplifier 213 and a speaker 215. It is to be noted that other components may be present but have not shown for the purpose of simplicity and tractability.

In certain embodiments, the control unit 207 may be configured to perform various functionalities, such as, for example, synchronization with other elements of the system 300, instructing the processor 209 to generate narrow-band signals, providing certain associated information such as frequency information or timing information to other components, or the like. In some non-limiting cases, the control unit 207 and the processor 209 could be implemented by the processing unit 306. The processor 209 may be configured to generate narrow frequency band signals in accordance with the instructions received from the control unit 207. The generated signals are narrow-band, generally single tone, within a frequency range of 0 to 1000 Hz. In some non-limiting implementations, the acoustic signal could be generated with a frequency generally below 100 Hz, for instance when investigating communication networks and fiber cables buried underground, as low frequencies generally have better penetration.

The digital signals are provided to the DAC 211 in order to convert the digital signals to analog signals. It is to be contemplated that in certain embodiments the power associated with the analog signals may not be sufficient to drive the speaker 215. As such, the analog signals may be fed to amplifier 213 to increase the power of the analog signals to sufficient level so that they can adequately drive speaker 215.

With reference to FIG. 5, a method 600 for inspecting a fibered optical communication path, using the system 300 described above, will now be described. The method 600 is described below as performed by the controller 302, but in some implementations it is contemplated that the method 600 could be performed by the processing unit 306 or the processing unit 356.

The method 600 begins, at step 610, with causing, by the controller 302, the acoustic signal generator 206 to produce an acoustic signal. As is described above, the acoustic signal generator 206 is disposed near at least one fibered optical path 290 such that the acoustic signal causes a localized disturbance 291 in the fibered optical path 290.

The method 600 continues, at step 620, with causing, by the controller 302, a laser 310 to emit at least one optical pulse into the fibered optical path 290. As is mentioned above, from just one or a few pulses to many pulses (10,000 or 100,00 pulses, for example) could be used, depending on the Signal-to-Noise (SNR) desired and other implementation specific details. It should be noted that the exact number of pulses necessary to perform the method 600 could depend on various technical details of the system.

The method 600 then continues, at step 630, with detecting, by the detector 312 communicatively connected the controller 302, a plurality of reflected optical signals with a plurality of different arrival times. As is described above, the plurality of reflected optical signals are Rayleigh backscattered signals from different points along the fibered path 290, where the signals scattered from different distances from the laser source 310/the detector 312 arrive at the detector 312 with different arrival times.

The method 600 continues, at step 640, with determining, by the controller 302, a distance traveled by each reflected optical signals. The distance traveled by each reflected signal is determined based on its arrival time at the detector 312 and the emission time of a source pulse from the laser source 310, the source pulse simply being the optical pulse from which light in a particular backscattered/reflected signal originated. Having determined the distance traveled and the arrival time for each pulse, a data set of the backscattered irradiance as a function of arrival time and distance traveled is formed. In some implementations, the dataset could be formed as function of emission time, rather than arrival time.

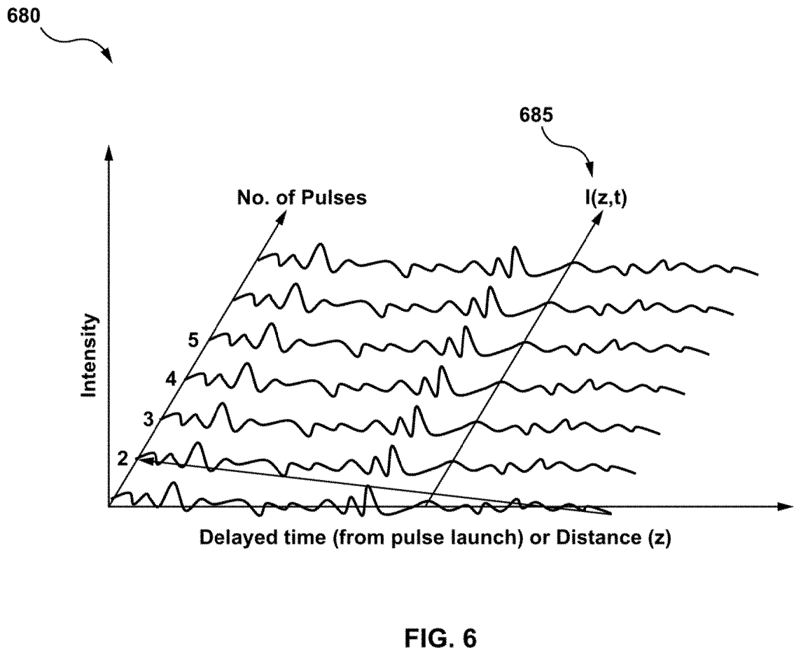

One non-limiting example of such a data set 680 is illustrated in FIG. 6, where the backscattered irradiance (z-axis) is plotted for each pulse (time of emission plotted along the y-axis) as a function of distance traveled by each pulse (x-axis).

The method 600 terminates, at step 650, detecting, by the controller 302, the phase oscillation introduced by the localized disturbance 291, for at least one distance traveled by the pulses. For instance, a slice 685 of the irradiance function of the plot 680 shows the irradiance function as a function of time for a particular subgroup. It is contemplated that different methods could be used to detect the phase oscillation/modulation, also referred to herein as tone detection. Generally, the acoustic tone is determined by performing spectral analysis on the time-domain signal. In at least some non-limiting implementations, detecting the phase oscillation through spectral analysis could performing a fast Fourier transform (FFT) of the irradiance function over time for one or more (or all) of the signal subgroups. In using an FFT treatment method, the phase oscillation frequency corresponding to the acoustic signal can readily be isolated and detected.

Based on detection of the phase oscillation in one or more of the fibered paths, a variety of different actions could be taken, the exact choice of action being generally outside the scope of the present description. For example, operators of the optical network 200 could use the determination to label, identify, or otherwise signal the co-location of all the fibered paths determined to be within the range of the acoustic signal generator 206 at some specific location. As another non-limiting example, detection of the phase oscillation at one or more location (for instance by moving the acoustic signal generator 206) could be used to organize or re-organize working and protection path pairs, such that such pairs are sufficiently separate and disjoint to operate as working and protection pairs of fibered communication paths.

With reference to FIG. 7, another method 700 for inspecting a fibered optical communication path, using the system 300 described above, will now be described. As is mentioned briefly above, the system 300 can further be operated based on a principle of emitting a pair of pulses for investigating fibered optical communication paths. The method 700 is similarly described below as performed by the controller 302, but in some implementations it is contemplated that the method 700 could be performed by the processing unit 306 or the processing unit 356.

The method 700 begins, at step 710, with launching, by the acoustic signal generator 206, the single tone acoustic signal near the fibered optical communication path under test (for example path 290 of FIG. 2).

The method 700 continues, at step 720, with sending, by the laser source 310, two optical pulses with a pre-determined time separation ΔT. The pre-determined time separation is chosen based on a desired spatial resolution, where the time separation of the two pulses determines the distance difference traveled by the two pulses arriving back at the detector 312 at the same time. In some non-limiting implementations, it is noted that a single pulse, with an adequate pulse duration, could be used in place of the pair of pulses in the method 700. The time separation ΔT is pre-determined in the sense that it was determined or decided or settled upon in some fashion at some time prior to the step 720.

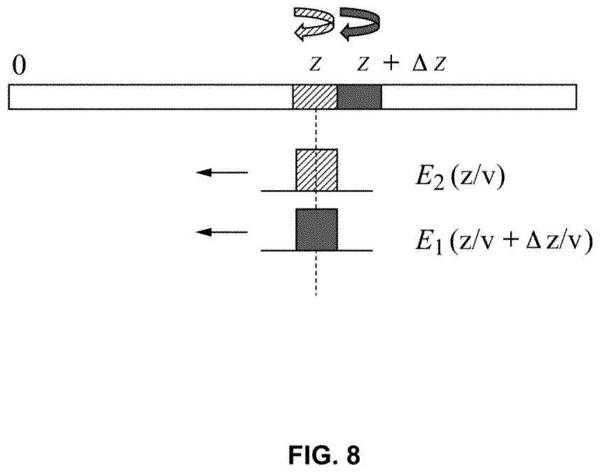

Physical separation of the two backscattered signals from the two pulses, arriving at the detector 312 at a same time, is illustrated in FIG. 8. The relation is specifically set out in Equation (2) below, where z is distance and a is the speed of light in the fiber under inspection. It should be noted that Eq. (2) is a slightly modified version of Eq. (1).

$$Δ T = \frac{2 Δ z}{v} \qquad ( 2 )$$

The method 700 then continues, at step 730, with receiving, at the detector 312, the reflected optical power for a given period of time. For a given pre-determined time separation ΔT, the first pulse reflected from a location (z) and the second pulse reflected from a location (z+Δz) arrive at the detector 312 at the same time and therefore interfere. Therefore, the optical power, i.e. an irradiance I(z), arriving at the detector 312 is determined by a superposition of the two pulses, set out in Equation (3) below. The irradiance includes an interference term partially determined by the phase difference experienced by each of the two pulses during propagation through the fiber.

$$I ( z ) = {\vert {E}_{1} ( \frac{z}{v} + \frac{Δ z}{v} ) \vert}^{2} + {\vert {E}_{2} ( \frac{z}{v} ) \vert}^{2} + 2 \vert {E}_{1} \vert \vert {E}_{2} \vert cos ( φ ) \qquad ( 3 )$$

The change of irradiance dI(z) over distance in the fiber (determining the difference in phase between the reflection point of the first pulse and the reflection point of the second pulse) is then recorded by the controller 302 and/or the processing unit 306, along with the time of pulse launch.

The steps 720 and 730 are then repeated for a chosen number of pulse samples in order to build a sufficient data, the Signal-to-Noise ratio generally decreasing with increasing pulse sample sizes.

Once the pre-determined number of pulses have been sent and a sufficient data set of optical power versus time has been established, the method 700 continues, at step 740, with performing tone detection of the acoustic signal frequency for each distance traveled by the pulse pairs, as is described above with reference to the method 600. Otherwise stated, at step 740, the processing unit 306 determines which at which distances the reflected signals have a phase modulation introduced by the localized disturbance 291 due to the acoustic signal, based at least in part on their arrival time(s). In some implementations, the method 700 could terminate with simply determining distance to the localized disturbance 291 and hence the location of a portion of the fibered path 290 relative to the acoustic signal generator 206.

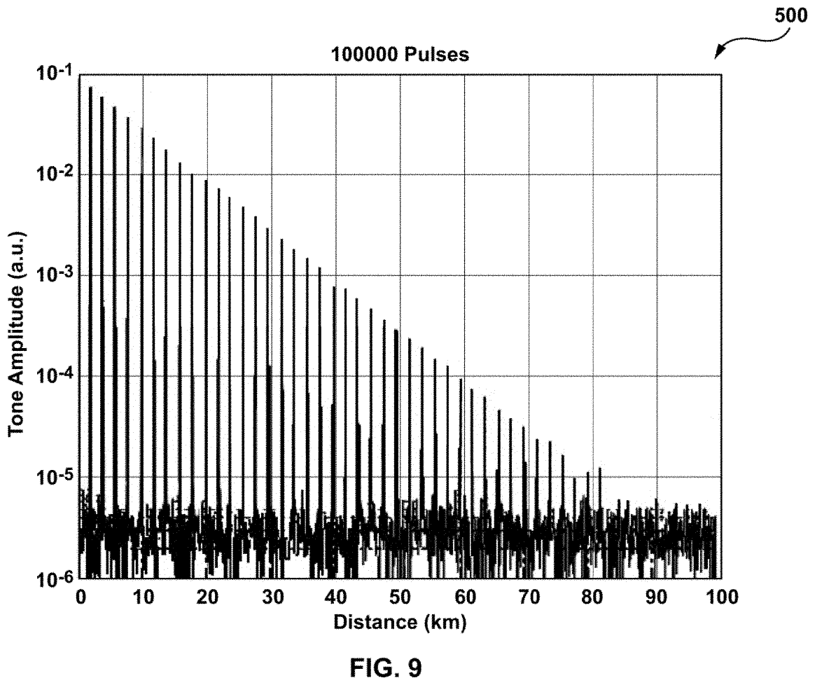

In some non-limiting implementations, the method 700 could terminate, at step 750, with plotting the tone amplitude versus distance. With the acoustic signal generator 206 disposed at one position along the fibered optical communication path 290, 292, there should be one strong peak at the location along the path 290, 292 and some low level noise which is mostly suppressed by exclusion of phase variations at frequencies other than the acoustic signal. An example of such a graph is included in FIG. 9, although as is described below, the acoustic signal was simulated along multiple positions of e fiber.

FIG. 9 illustrates results 500 from a numerical simulation of tone detection according to certain embodiments of the present technology. The results shown are a simulation of the distance over which an acoustic signal induced phase oscillation can be detected. An implementation of the two-pulse method (described above with reference to the method 700 shown in FIG. 7) was simulated for a 0.25 dB/km fiber attenuation coefficient, 100,00 total pulses, and with the acoustic signal simulated at regular intervals along the fiber. As can be seen from the simulated results, the single-tone/narrow-band acoustic signal can be detected above background noise up to 80 km from source. In the prior art generally, reflected signals can generally be isolated for distances of up to 40-45 km. The improvement over the prior art is due in part to the use of a single-tone/narrow-band acoustic signal, which can be targeted in and isolated from background noise in the reflected signals.

Thus by virtue of system 300 and methods 600, 700 in some implementations, the physical location of a fibered optical communication path or possible interactions between two nominally independent fibered communication paths could be determined in a cost effective and an efficient manner without adding much hardware complexity.

It is to be understood that the operations and functionality of systems 200, 300, constituent components, and associated processes may be achieved by any one or more of hardware-based, software-based, and firmware-based elements. Such operational alternatives do not, in any way, limit the scope of the present disclosure.

It will also be understood that, although the embodiments presented herein have been described with reference to specific features and structures, it is clear that various modifications and combinations may be made without departing from such disclosures. The specification and drawings are, accordingly, to be regarded simply as an illustration of the discussed implementations or embodiments and their principles as defined by the appended claims, and are contemplated to cover any and all modifications, variations, combinations or equivalents that fall within the scope of the present disclosure.

What is claimed is:

1. A method for inspecting at least one fibered optical communication path, the method comprising:
causing, by a controller, an acoustic signal generator to produce an acoustic signal, the acoustic signal generator being disposed near the at least one fibered optical path;
causing, by the controller, a laser to emit at least one optical pulse into the at least one fibered optical path, the at least one optical pulse being emitted at an emission time;
detecting, by at least one detector communicatively coupled to the controller and operatively connected to the at least one fibered optical path, a plurality of reflected optical signals, each reflected optical signal having an arrival time;
determining, by the controller, a distance traveled by each of the plurality of reflected optical signals, in which the distance traveled by a given reflected signal is determined at least in part on the arrival time of the given reflected signal and the emission time of the at least one optical pulse; and
detecting, by the controller, for at least one distance traveled by the given reflected signal, a phase oscillation induced at least in part by the acoustic signal.

2. The method of claim 1, wherein:
the at least one detector is a first detector;
the at least one fibered optical path is a first fibered optical path;
the plurality of reflected optical signals is a first plurality of reflected optical signals; and
the method further comprises:
detecting, by a second detector communicatively coupled to the controller and operatively connected to a second fibered optical path, a second plurality of reflected optical signals from the second fibered optical path;
detecting, by the controller, the phase oscillation; and
determining, by the controller, that at least a portion of the second fibered optical path is disposed in a same fiber cable as at least a portion of the first fibered optical path.

3. The method of claim 2, further comprising determining a second distance traveled by a portion of the second plurality of reflected optical signals having the phase oscillation, wherein the second distance indicates a distance between the second detector and the acoustic signal generator.

4. The method of claim 1, further comprising:
causing the acoustic signal generator to produce the acoustic signal at a second position, the second position being near a different portion of the at least one fibered optical path;
detecting a second plurality of reflected optical signals, reflections in the fibered path from each one of the plurality of optical pulses creating some of the plurality of reflected optical signals, each one of the second plurality of reflected optical signals having a second arrival time;
determining a second distance traveled by each of the second plurality of reflected optical signals; and
detecting, for at least a portion of the second plurality of reflected optical signals, the phase oscillation introduced at least in part by the acoustic signal at the second position,
the second distance traveled by the portion of the second plurality of reflected optical signals having the oscillation indicating a distance along the fibered path from the detector to the acoustic signal generator at the second position.

5. The method of claim 4, further comprising:
receiving at least one indication of physical locations of the first position and the second position of the acoustic signal generator;
mapping physical positioning the at least one fibered optical path based at least in part of the at least one indication of the physical locations of the first position and the second position.

6. The method of claim 1, wherein:
causing the laser to emit the at least one optical pulse includes causing the laser to emit a plurality of pairs of two optical pulses separated by a pre-determined time delay; and
determining the arrival time of each one of the plurality of reflected optical signals comprises:
detecting an interference at the at least one detector of reflections of each pair of two optical pulses.

7. The method of claim 1, wherein causing the acoustic signal generator to produce the acoustic signal comprises causing the acoustic signal generator to produce a narrow-band acoustic signal.

8. The method of claim 7, wherein detecting the phase oscillation includes suppressing signals with phase oscillations not corresponding to the narrow-band acoustic signal.

9. The method of claim 8, wherein detecting the phase oscillation comprises performing a fast Fourier transform (FFT) of an irradiance of the plurality of reflected optical signals, the irradiance being a function of the arrival time of portion of the second plurality of reflected optical signals.

10. The method of claim 1, wherein the plurality of reflected optical signals are produced by Rayleigh backscattering at a plurality of distances along the at least one fibered optical path.

11. The method of claim 1, wherein determining the distance traveled by a given reflected signal of the plurality of reflected optical signals through the at least one fibered optical path comprises:
determining a time difference between the arrival time of the given reflected signal and the emission time of a given source pulse; and
calculating the distance based on the time difference and the speed of light in the at least one optical communication path.

12. The method of claim 1, wherein:
the at least one optical pulse includes at least a first optical pulse and a second optical; and
the plurality of reflected optical signals includes at least a first plurality of reflected optical signals originating from the first optical pulse and a second plurality of reflected optical signals originating from the second optical pulse.

13. A system for determining a fibered communication path, comprising:
a controller;
a laser source communicatively coupled to the controller, the laser source being configured for operatively coupling to an optical communication path;
at least one detector communicatively coupled to the controller, the at least one detector being configured to receive signals from the optical communication path; and
an acoustic signal generator communicatively coupled to the controller,
the controller being configured to:
cause, by the controller, the acoustic signal generator to produce an acoustic signal near at least one fibered optical path;
cause, by the controller, the laser source to emit at least one optical pulse into the at least one fibered optical path, the at least one optical pulse being emitted at an emission time;
detect, by the at least one detector, a plurality of reflected optical signals, each one of the plurality of reflected optical signals having an arrival time;
determine, by the controller, a distance traveled by each of the plurality of reflected optical signals, in which the distance traveled by a given reflected signal is determined at least in part on the arrival time of the given reflected signal and the emission time of the at least one optical pulse; and
detect, by the controller, for at least one distance traveled by the given reflected signal, a phase oscillation produced at least in part by the acoustic signal.

14. The system of claim 13, wherein:
causing the laser to emit the at least one optical pulse includes causing the laser to emit a plurality of pairs of two optical pulses separated by a pre-determined time delay; and
the controller is further configured to determine the arrival time of each one of the plurality of reflected optical signals by detecting an interference at the at least one detector of reflections of each pair of two optical pulses.

15. The system of claim 13, wherein the controller is configured to cause the acoustic signal generator to produce the acoustic signal by causing the acoustic signal generator to produce a narrow-band acoustic signal.

16. The system of claim 15, wherein the controller is configured to detect the phase oscillation by suppressing signals with phase oscillations not corresponding to the narrow-band acoustic signal.

17. The system of claim 16, wherein the controller is configured to detect the phase oscillation by performing a fast Fourier transform (FFT) of an irradiance of the plurality of reflected signals, the irradiance being a function of the arrival time of the plurality of reflected signals.

18. The system of claim 13, wherein the plurality of reflected optical signals are produced by Rayleigh backscattering at a plurality of distances along the at least one fibered optical path.

19. A method for inspecting a fibered optical communication path, the method comprising:
launching a single tone acoustic signal near the fibered optical communication path;
sending, into the fibered optical communication path, a first two optical pulses separated by a pre-determined time separation;
receiving reflected optical power over an elapsed time;
repeating, for a pre-determined number of total pulses, sending additional two optical pulses separated by the pre-determined time separation and receiving the optical power over the elapsed time; and
performing tone detection, based at least in part on the single tone acoustic signal, on the optical power received.

20. The method of claim 19, wherein performing tone detection comprises detecting phase oscillation corresponding to the single tone acoustic signal in the reflected optical power received over the elapsed time.
